(19) United States
(12) Patent Application Publication
(10) Pub. No.: US 2006/0261009 A1
(43) Pub. Date: Nov. 23, 2006

(54) Extraction of dihydrogen oxide stratagies and solutions

(76) Inventors: Clifton Raymond Jacks, Rio Rancho, NM (US); Scott Jace Norman, Corrales, NM (US); Kevin Michael Calnan, Corrales, NM (US)

Correspondence Address: Clifton Jacks, Scott Norman & Kevin Calnan, P.O. Box 181, Corrales, NM, 87048-0181, US

(21) Appl. No.: 11/205,393

(22) Filed: Aug. 17, 2005

Related U.S. Application Data
(60) Provisional application No. 60/683,720, filed on May 23, 2005.

(51) Int. Cl. B01D 61/00

(52) U.S. Cl. 210/652; 210/747; 166/265; 210/170; 166/53

(57) ABSTRACT

A method and product are disclosed for extracting only dihydrogen oxide from subsurface strata containing a currently unusable product, or “MUC” (Matrix Ubiquitous Crude) with no environmental impact. EDOM Extraction of Dihydrogen Oxide Module) will extract water from the currently unusable product, Matrix Ubiquitous Crude for national use, emergencies and homeland security as well as the American public's common good. Extraction of Dihydrogen Oxide Module consists of a single or multiple stage replaceable subterranean module placed within the inside casing of a well casing that facilitates a customized water purification system designed for treatment of each specific quality of Matrix Ubiquitous Crude. The intended ultimate end use of the produced water will determine each Extraction of Dihydrogen Oxide Module's internal composition of customized water treatment components as dictated by comprehensive laboratory analysis.

### CROSS REFERENCE TO RELATED APPLICATIONS

This patent application claims the priority benefit from U.S. Provisional Patent Application Ser. No. 60/683,720 filed on May 23, 2005, entitled “EDOM” (Extration of Dihydrogen Oxide Module).

### BACKGROUND OF THE INVENTION

1. Field of the Invention

The invention relates to a process for extracting only dihydrogen oxide water molecules from a subterranean Matrix Ubiquitous Crude containing strata.

In many locations water is produced from a permeable subsurface zone (a so-called aquifer or aquifer layer) to surface through a well. Often, the water is too saline to be usable and therefore requires extraction and possibly further purification in order to obtain a useful water quality, in particular potable water. Saline water is sometimes also referred to as brackish water.

2. Description of Prior Art

It is known from Perry's Chemical Engineers' Handbook, Sixth Edition, Robert Perry and Don Green p. 17-22 to 17-25 that a reverse osmosis separation process separates a solute from a solution by forcing the solvent to flow through a membrane by applying a pressure greater than the normal osmotic pressure. Four common membrane designs are spiral wound, hollow-fibre, tubular, plate-and-frame, and all of these designs can be used in an Extraction of Dihydrogen Oxide Module assembly according to the invention as well as simple sediment filtration, complex sediment filtration, deionization, distillation, electrodeionization, ultraviolet and ozonation.

It is also known to those skilled in the art that nano-filtration is a form of filtration that uses membranes to preferentially separate different fluids or ions. Nano-filtration is not as fine a filtration process as reverse osmosis, but on the other hand it does not require the same energy to perform the separation. Nano-filtration also uses a membrane that is partially permeable to perform the separation, but the membrane's pores are typically much larger than the membrane pores that are used in reverse osmosis. Reverse osmosis membranes can also be dense membranes without pores. Nano-filtration rejects a lot of the smaller organics that pass through other membranes such as ultrafiltration membranes and yet can pass more water at lower operation pressures than can reverse osmosis, resulting in a more energy/cost efficient procedure. It can remove particles in the 0.1-0.001 mu.m molecular size range (like humic acid and organic colour bodies present in water) and can reject selected (typically polyvalent) salts. A membrane that can be used for desalination can normally also remove further contaminants that may be present in the water to be treated, such as bacteria, and therefore by desalination often also some degree of further cleaning/purification is achieved. The opposite is not always true, i.e. not all membranes that can be used for water cleaning also result in desalination. Hydrophilic membranes are membranes having an affinity for water, that are solid in structure yet allowing water molecules to pass through. Suitably these membranes are operated by heating the feed so that vapor is formed, water molecules of which vapor are allowed to diffuse through the membrane. Heating can for example be achieved by using solar energy. The passed through water molecules are then condensed on the permeate side of the membrane to collect the water. Hydrophilic membranes can produce highly desalinated water.

In a known method to desalinate saline aquifer water that is received at surface from an aquifer layer through a well, the water is transported via a pipeline to a membrane separation unit at some distance from the wellhead. U.S. Pat. No. 3,283,813 discloses a downhole desalination process, wherein saline water, as present at surface, is being pumped into a subsurface earth formation, using an injection well. Fresh water percolating through the formation is pumped back to surface through a water production well, which is located at a suitable distance from the injection well. A reject stream of concentrated brine is disposed of in another subsurface layer, located beneath the osmotic earth layer and isolated from it by an impermeable subsurface barrier.

Furthermore, UK patent application GB 2068774 and U.S. Pat. Nos. 4,125,463; 5,366,635; 5,916,441 describe a process where seawater is pumped from top into a well fitted with a subsurface membrane, or a system where such a membrane is installed at seabottom. In either case, the membrane is installed at a certain depth so as to create a hydrostatic head that provides the energy for driving a reverse osmosis desalination unit.

U.S. Pat. No. 6,190,556 discloses a nano-filtration and reverse osmosis membrane desalination system for producing fresh water from seawater in a pressure vessel.

A major disadvantage of existing, membrane-based desalination techniques for saline aquifer waters is that the feed water is often very clean at source (except for its salinity), but becomes contaminated with solids and/or bacteria/algae in the production/transportation system.

In addition, temperature and pressure changes may give rise to the precipitation of mineral particles (‘scaling’) upstream of the membrane separation unit. Corrosion of steel system components will generate solid corrosion products, and bacteria if not treated may colonize the upstream system and cause bio-fouling, such as formation of a so-called biofilm. When left un-addressed, all these phenomena result in rapid membrane fouling, and a sharp drop in performance, to the point that membranes need to be exchanged frequently.

A comprehensive, effective chemical treatment system is required in existing installations to negate this effect, which places an appreciable burden on operators and logistics, and incurs excessive extra cost, which can amount to as much as 70% of the total operating cost. Bio-fouling, for example, is combated by injecting chemicals into the flowline, so-called biocides.

### SUMMARY OF THE INVENTION

In accordance with the invention Matrix Ubiquitous Crude, as present in a permeable subsurface zone, is tapped into via a well.

The Matrix Ubiquitous Crude is then routed through an Extraction of Dihydrogen Oxide Module single or multiple stage assembly of one or more membranes, which is installed in the well's casing in such a way that it can easily be retrieved and/or inserted via the production tubing.

The extracted dihydrogen oxide emanating from the Extraction of Dihydrogen Oxide Module's product (permeate) port will be produced to surface, either by natural forces or by pump assistance. Suitably, the Extraction of Dihydrogen Oxide Module will produce water of whatever quality is necessary to meet the demand needed.

Thus, Matrix Ubiquitous Crude is accessed from a subsurface strata layer by drilling a well in which an Extraction of Dihydrogen Oxide Module single or multiple stage replaceable subterranean module consisting of one or more extraction and/or purification technologies is arranged which extracts dihydrogen oxide into a purified water stream which is produced through the well to surface and possibility a secondary concentrated stream of impurities and/or brine reject.

Preferably, the secondary impurity/brine reject stream remains in the subsurface disposal zone. The disposal zone is suitably formed by a permeable earth formation layer which is at least partly hydraulically isolated from the source aquifer layer.

Suitably, the Extraction of Dihydrogen Oxide Module replaceable subterranean module may consist of one or more reverse osmosis, nano-filtration, non-porous hydrophilic, semi-permeable and/or other water extraction and/or purification technologies, and the Extraction of Dihydrogen Oxide Module replaceable subterranean module may suitably consist of a plurality of stacked substantially tubular membrane modules.

The Extraction of Dihydrogen Oxide Module replaceable subterranean module can in particular include a hybrid membrane assembly, which is an assembly including different types of membranes, in particular both a reverse osmosis as well as a nano-filtration membrane.

Preferably, the Extraction of Dihydrogen Oxide Module single or multiple stage replaceable subterranean module assembly is mounted downstream of a downhole pump, e.g. an electrical submersible pump (ESP) or a hydraulic pump, which pumps the primary extracted (purified) water stream to surface, such that the pump provides both inflow and production/disposal energy to the membrane assembly. The electrical submersible pump and membrane assembly may be built together into a sectional units, which are retrievable from, and insertable into, a downhole receptor near the inflow region of the well, using connections to the production tubing as a hoisting system.

Various operating parameters, such as the composition and/or flowrate of the dihydrogen oxide produced to surface, pressures and temperatures at different points downhole, flow rate to surface, may be monitored with downhole monitoring devices, and the data are transmitted to surface via communication links such as an electric or fibre optical cable and/or wireless electromagnetic or acoustic telemetry systems.

Preferably, the impurities and/or reject water stream (retentate), which is a concentrated brine, also normally containing impurities and contaminants, is not produced to surface, but left behind in the subsurface brine disposal zone. This is usually a deeper permeable layer, which has no or only limited fluid connection to the original source aquifer, i.e. which is at least partly hydraulically isolated from the source aquifer layer. In view of the volumes concerned, disposal will almost certainly require pump assistance.

It is, however, also possible to transport the concentrated brine retentate to surface, in particular when there is no disposal zone available. The retentate can then e.g. be used as so-called completion brine or workover brine, or for the production of drilling mud.

In accordance with the present invention there is also provided a well for producing extracted dihydrogen oxide from a subsurface Matrix Ubiquitous Crude containing layer to surface, which well comprises a subterranean Matrix Ubiquitous Crude containing layer and an Extraction of Dihydrogen Oxide Module single or multiple stage replaceable subterranean module assembly of one or more extraction and/or purification technologies for extracting water into a primary purified water stream and a secondary concentrated brine reject stream, and a conduit for transporting extracted fresh water to surface.

The invention also relates to Extraction of Dihydrogen Oxide Module assemblies for use in a method or in a well of the invention, in particular Extraction of Dihydrogen Oxide Module assemblies comprising a plurality of stacked purification technologies, and membrane assemblies built into a sectional and/or single unit with a downhole pump.

The main advantage of the invention is that it seeks to alleviate or eliminate the disadvantages of traditional desalination systems, as described above.

It offers greater simplicity, essentially by keeping the feed water clean rather than allowing it to become spoiled first in a potentially hot surface conduit (e.g. due to sunlight heating causing algae growth and biofilm formation), and subsequently trying to treat it back to near-original quality specifications (except for its salt content).

A great advantage of the invention is it minimizes operator intervention and monitoring. Because the Extraction of Dihydrogen Oxide Module is a self contained unit it requires no field service. When the inner filtration assembly is exhausted the module is removed and simply replaced with a new one and the exhausted unit is returned to the factory for refurbishing.

Another advantage is the reduction in infrastructure at surface or subsea, which contributes to elimination of the possibility of environmental incidents the surface and protects against vandalism.

A further advantage is that the bio-fouling is unlikely to happen downhole, so that injection with biocide chemicals is not or at least not as frequently needed as in known desalination methods. Suitably, the well is drilled and completed carefully so as to prevent bacteria/algae to grow downhole. Optionally, the well can be subjected to an initial treatment with biocides after completing the well and before starting up production.

The present invention relates to desalinating downhole aquifer water, which is different in several aspects from known methods for desalinating seawater.

The present invention would ideally be used in the petroleum industry to separate water from produced oil for other uses (irrigation); produce sterile, drinkable water; irrigation for agriculture; commercial applications such as food processing plants; produce sanitized water for maintenance and cleaning (ie: processing plants); make-up water for pretreatment of boiler feed; municipal treatment for small systems and rural water supplied (sub-divisions); irrigation for golf courses and public parks; process potable water at RV parks, campsites, national parks; remove contaminates from mining effluent, cotton gins, drainage; remove contaminates from municipal “Non-Point” pollution sources; arsenic removal; indian pueblos/reservations water supplies; private wells (commercial/industrial), residential; National Strategic Water Reserve; irrigation for large growers/nursery's/farms/orchards; hydroponics; power generating utilities; wastewater reclamation; contaminate removal backup for municipal distribution systems; extraction of pure water from Matrix Ubiquitous Crude; and for utilities and electrical plants.

These and other objects of the present invention will become clear upon study of present invention described herein by those skilled in this art. The details of the this description should not be construed as limiting the scope of the present invention as set forth in the appended claims hereto, but merely illustrative of the manner in which the present invention may employed in a useful manner by those skilled in this art.

### BRIEF DESCRIPTION OF THE DRAWINGS

FIG. 1 is a schematic longitudinal sectional overview of a production tubing retrievable staged subterranean module extraction of Dihydrogen Oxide Module) downhole pump and membrane assembly according to the invention.

FIG. 2 is a schematic longitudinal sectional view of a downhole pump and membrane assembly (Extraction of Dihydrogen Oxide Module) according to the invention which is connected to the lower end of a production tubing.

### DESCRIPTION OF PREFERRED EMBODIMENTS

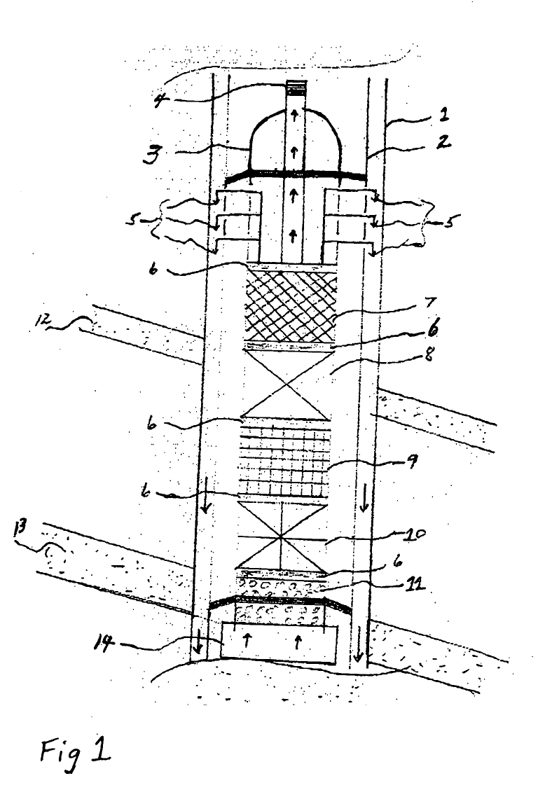

Referring to FIG. 1 there is shown a fresh water production well 1 comprising a downhole assembly of aquifer water desalination and/or purification membranes 7,8,9 & 10 which are enclosed within the Extraction of Dihydrogen Oxide Module together with an Electrical Submersible Pump (ESP) 14 into a single retrievable unit, which unit can be hoisted up and down via the purified water production tubing 4. The membrane assembly and pump are designed so that they can be hoisted up as a single unit. Also, the membrane assembly can be formed of stacked cylindrical or tubular membrane modules which can be enclosed within the Extraction of Dihydrogen Oxide Module. A disposal bypass 5 extends from the upper end of the membrane assembly 3 through the inner casing into a brine disposal zone at the bottom of the well 1. A downhole flow and/or composition monitoring device 15 is connected by an electrical or fibre optical cable to production monitoring equipment at the earth surface. Flow of saline aquifer water from an aquifer layer 13 will be taken into the tubing through an inlet intake at the lower end of the casing then drawn into the ESP 14. From there it will be fed into the desalination membrane assembly 3. Out of the desalination assembly 3, a secondary stream of concentrated brine will flow down from the upper end of the membrane assembly 3 through the inner casing and into a saline reject water disposal zone near the bottom of the well 1. The fresh water which passes through the semi-permeable wall of the desalination and/or purification membranes 7,8,9 & 10 flows up through the production tubing 4 to surface. The data recorded by the downhole monitoring devices 15 are transferred to surface by the signal/power transmission cable or by a wireless data telemetry link.

The Electrical Submersible Pump 14 is shown mounted inside the lower portion of the Extraction of Dihydrogen Oxide Module assembly 3. The ESP 14 can also be mounted on top of the membrane assembly, but so that with respect to the water flow it remains upstream of the feed side of the membrane.

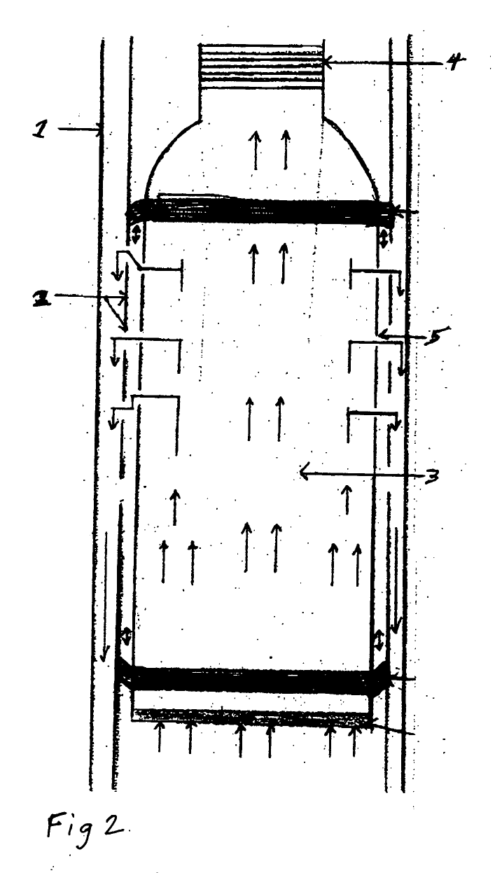

Referring now to FIG. 2 there is shown a fresh water production well 1 which is equipped with a downhole aquifer water desalination system comprising an Extraction of Dihydrogen Oxide Module 3. Pure water flows from the membrane and pump assembly to the surface through the production tubing 4. Saline reject water returns to the disposal zone near the bottom of the well through perforations 5 in the well casing 2. Fresh water flows out the top of the Extraction of Dihydrogen Oxide Module, and through the production tubing 4 to surface. The data recorded by the downhole monitoring device 15 will be transferred to surface by a signal and/or power transmission cable.

Electrical power required for operating the present invention, in particular for driving a downhole pump, can be generated by means of photovoltaic cells near the wellhead. This can be of particular advantage for application in locations remote from access to a power grid, such as desert areas. As a result, a single well with a minimum of surface installations can provide extracted dihydrogen oxide and no waste streams.

We claim:

1. A method for extracting only dihydrogen oxide from Matrix Ubiquitous Crude containing substrata formations, the method comprising the steps of: providing a well extending from the surface into a Matrix Ubiquitous Crude containing strata, the well contains a single or multiple stage replaceable subterranean module (Extraction of Dihydrogen Oxide Module) located within the well casing effectively designed to extract only the dihydrogen oxide molecules to provide the specific quality of product water desired and leaving behind all the substances which the H2O contained before becoming pure water.

2. The method of claim 1, wherein impurities and/or secondary brine reject stream is left behind in the subsurface strata from which it originated.

3. The method of claim 1, wherein the Extraction of Dihydrogen Oxide Module replaceable subterranean module may contain one or more reverse osmosis membrane.

4. The method of claim 1, wherein the Extraction of Dihydrogen Oxide Module replaceable subterranean module may contain one or more nano-filtration membrane.

5. The method of claim 1, wherein the Extraction of Dihydrogen Oxide Module replaceable subterranean module may contain one or more non-porous hydrophilic membrane.

6. The method of claim 1, wherein the Extraction of Dihydrogen Oxide Module replaceable subterranean module may contain one or more semi-permeable membrane.

7. The method of claim 1 wherein the Extraction of Dihydrogen Oxide Module replaceable subterranean module may contain multiple stacked substantially tubular membrane modules.

8. The method of claim 1 wherein the dihydrogen oxide (pure water) stream is lifted to the surface by a pump.

9. The method of claim 8 wherein the pump is arranged downhole in the well.

10. The method according to claim 8, wherein the pump is arranged upstream of the membrane assembly.

11. The method of claim 8 wherein the pump and Extraction of Dihydrogen Oxide Module replaceable subterranean module assembly is built into sectional units which are retrievable from, and insertable into, the well casing near an inflow region of the well, using production tubing hoisting system.

12. The method according to claim 8 wherein the pump is an electrical submersible pump.

13. The method according to claim 8 wherein the pump is a hydraulic pump.

14. The method of claim 1 wherein the composition of the dihydrogen oxide produced to surface, flow rate within the primary substrata source of Matrix Ubiquitous Crude and/or secondary purified water streams, pressures and temperatures at different points within the well and flow rate to surface, are monitored with downhole monitoring devices, and the data are transmitted to surface via communication links.

15. The method of claim 14 wherein the communication link comprises an electric cable.

16. The method of claim 14 wherein the communication link comprises a fibre optical cable.

17. The method of claim 14 wherein the communication link comprises a wireless electromagnetic telemetry system.

18. The method of claim 14 wherein the communication link comprises an acoustic telemetry system.

19. A well for producing dihydrogen oxide from a subsurface source of Matrix Ubiquitous Crude to the surface, which well comprises an Extraction of Dihydrogen Oxide Module replaceable subterranean module assembly of one or more customized water purification technologies for extracting the dihydrogen oxide molecules into a primary purified water stream and a secondary concentrated brine reject stream, and a conduit for transporting desalinated fresh water to surface.

20. The well according to claim 19, further comprising means for leaving behind impurities and/or concentrated brine in the subsurface strata where it originated.

21. The well according to claim 19 wherein the Extraction of Dihydrogen Oxide Module replaceable subterranean module may contain one or more reverse osmosis membranes.

22. The well according to claim 19 wherein the Extraction of Dihydrogen Oxide Module replaceable subterranean module may contain one or more nano-filtration membranes.

23. The well according to claim 19 wherein the Extraction of Dihydrogen Oxide Module replaceable subterranean module may contain one or more non-porous hydrophilic membranes.

24. The well according to claim 19 wherein the Extraction of Dihydrogen Oxide Module replaceable subterranean module may contain one or more semi-permeable water extraction and/or purification membranes.

25. The well according to any one of claim 19 wherein the Extraction of Dihydrogen Oxide Module replaceable subterranean module may contain a plurality of stacked substantially tubular membrane modules.

26. The well according to claim 19 further comprising a downhole pump for generating the pressure needed for membrane separation.

27. The well according to claim 19 further comprising a downhole pump for pumping extracted dihydrogen oxide to surface.

28. The well according to claim 19 further comprising a containment/retention system for returning and/or leaving impurities and/or concentrated brine into the substrata formation where it originated.

29. The well according to claim 25, wherein the Extraction of Dihydrogen Oxide Module replaceable subterranean module may be arranged upstream of the pump.

30. A membrane assembly for use in a method according to claim 1, which membrane assembly is retrievable from, and insertable into, an aquifier well, and which membrane assembly comprises a plurality of stacked membrane modules.

31. An Extraction of Dihydrogen Oxide Module assembly for use in a method according to any one of claims 1, and which Extraction of Dihydrogen Oxide Module assembly is built into sectional units with a pump, each unit is retrievable from, and insertable into, the well casing receptor near the inflow region of the well, using a production tubing hoisting system.
